(19) United States
(12) Patent Application Publication
(10) Pub. No.: US 2009/0129930 A1
(43) Pub. Date: May 21, 2009

(54) Trolling motor propeller with elastomeric hub

(75) Inventor: Mikel E. Janitz, Collinsville, OK (US)

Correspondence Address: WILLIAM D. LANYI, MERCURY MARINE, W6250 PIONEER ROAD P.O. BOX 1939, FOND DU LAC, WI, 54936-1939, US

(73) Assignee: Brunswick Corporation

(21) Appl. No.: 11/136,109

(22) Filed: May 24, 2005

(51) Int. Cl. B64C 11/04

(52) U.S. Cl. 416/204 R

(57) ABSTRACT

A propeller for a trolling motor has an inner hub and an outer hub. The inner hub is made of a synthetic elastomer so that relative rotational movement between the outer hub and a propeller shaft is permitted. This relative movement dampens the reactive forces during an impact between blades of the propeller and submerged objects, such as weeds. The elastic deformability of the inner hub also reduces noise that can be caused by imbalances contained in the propeller.

### BACKGROUND OF THE INVENTION

1. Field of the Invention

The present invention is generally related to a trolling motor propeller and, more specifically, to a trolling motor propeller which is provided with an elastically deformable central hub which decreases reactive forces when the propeller strikes an object.

2. Description of the Related Art

Many different types of propellers are known to those skilled in the art. Some marine propellers are intended for use with trolling motors. These propellers are typically made of a relatively hard plastic material or metal. Trolling motors typically use electric motors, in the range of 0.26 horsepower to 1.18 horsepower, to drive the propeller.

One desirable quality of a trolling motor is to provide motive force for a marine vessel without generating significant noise. Noise can be generated by the trolling motor when the blades of its propeller strike underwater objects, such as weeds.

U.S. Pat. No. 4,311,470, which issued to Blanchard on Jan. 19, 1982, describes a trolling motor which includes a shaft extending vertically under normal operating conditions and having a lower end. The shaft is supported by a boat hull. An electric motor is fixedly connected to the lower end of the vertical shaft and includes an output shaft.

U.S. Pat. No. 4,482,298, which issued to Hannon et al. on Nov. 13, 1984, describes a weedless propeller. The propeller, which is intended for use with a trolling motor, comprises a major hub having a plurality of propeller blades. The rearward end of the major hub is bluntly terminated immediately aft the trailing edge of the blades at the root of the blades. A secondary hub is connected to the forward end of the primary hub. The junction between the forward end of the secondary hub and the shroud of the engine or motor driving the propeller is spaced a substantial distance from the major hub and blades.

U.S. Pat. No. 4,861,313, which issued to Zeiser et al. on Aug. 29, 1989, describes an elastomeric shaft coupling for concentric shafts. A dual concentric shaft coupling arrangement is provided with both inner and outer rotatable assemblies. An inner assembly comprises an inner rotatable driving member, an inner rotatable driven member and an inner rotatable intermediate member that is connected therebetween. An outer assembly comprises an outer rotatable driving member, an outer rotatable driven member and an outer rotatable intermediate member connected therebetween.

U.S. Pat. No. 5,352,093, which issued to Hannon et al. on Oct. 4, 1994, describes a weedless propeller. The propeller is intended for use on low power motors, such as two horsepower or less electric trolling motors, and is provided with three or more blades on a hub wherein the hub diameter to the blade length is in the ratio of at least 1.250 to 1. The hub diameter to blade length ratio is such as to produce a propeller having increased performance and is substantially weedless.

U.S. Pat. No. 5,372,480, which issued to Van Meter et al. on Dec. 13, 1994, describes a replaceable and foldable blade boat propeller. The blades are easily removable from the propeller hub on an individual basis to permit quick replacement for repair and/or for substituting blades of different pitch comprising a hub adapted to fit over and attach to a driveshaft. It also comprises a plurality of removable blades positioned around the hub and extending radially therefrom. Each of the blades comprises a water engaging blade portion and a rigid tang extending from the base and of such blade portion.

U.S. Pat. No. 6,024,615, which issued to Eichinger on Feb. 15, 2000, discloses a vibration absorbing apparatus for a rotating system. The system incorporates an inertia mass that is disposed within a hollow portion of an impeller structure. The inertia mass is attached to one or more elastomeric members which are, in turn, attached to an inside surface of a tubular portion of the impeller structure. The annular inertia mass and its elastomeric legs are particularly designed to dampen and counteract a particular frequency at which the propulsion system vibrates when the internal combustion engine is operated at idle speed.

U.S. Pat. No. 6,478,543, which issued to Tuchscherer et al. on Nov. 12, 2002, discloses a torque transmitting device for mounting a propeller to a propeller shaft of a marine propulsion system. The device provides an adapter that is attached in torque transmitting relation with a propulsor shaft for rotation about a central axis of rotation. The first insert portion is attached in torque transmitting relation with the adapter and a second insert portion is attached in torque transmitting relation with a hub of the propulsor hub which can be a marine propeller or an impeller. A third insert portion is connected between the first and second insert portions and is resilient in order to allow the first and second insert portions, to rotate relative to each other about the central axis of rotation.

U.S. Pat. D473,567, which issued to Campbell on Apr. 22, 2003, describes a trolling motor propeller. This design patent shows one particular ornamental design for a trolling motor propeller and also illustrates several concepts regarding the construction of the propeller.

The patents described above are hereby expressly incorporated by reference in the description of the present invention.

It would be a significant benefit if a trolling motor propeller could be provided which decreases the sound level caused by the trolling motor as a result of the propeller striking an underwater object or as a result of an imbalance of the propeller. These vibrational and impact noises detract from the enjoyment of fishing and can adversely affect the likelihood of fishing success.

### SUMMARY OF THE INVENTION

A propeller for a trolling motor, made in accordance with a preferred embodiment of the present invention, comprises an outer hub made of a first material, a plurality of blades attached to the outer hub, and an inner hub made of a second material. The outer hub is configured to be rotatable about a central axis. The inner hub is disposed radially inwardly of the outer hub and is shaped to receive a propeller shaft therethrough. The inner hub is configured to be rotatable about the central axis in synchrony with the outer hub.

The second material, of the inner hub, is more elastically deformable than the first material, of the outer hub, in a preferred embodiment of the present invention. The second material can be an elastomeric material such as a natural or synthetic rubber compound. The first material, in a preferred embodiment of the present invention, can be plastic or metal.

The inner hub can be alternatively configured to be removably inserted into the outer hub or co-molded with the outer hub. When the propeller is attached to a trolling motor, the propeller shaft can be inserted through a central opening of the inner hub. The propeller shaft can be generally coaxial with the central axis. In some embodiments of the present invention, the inner hub can be provided with a plurality of discontinuities that are formed on a generally cylindrical outer surface of the inner hub. These discontinuities are shaped to be received in symmetrical discontinuities formed on an inner cylindrical surface of the outer hub. In applications where the inner hub is configured to be removably inserted into the outer hub, these matching discontinuities increase the gripping effect between the inner and outer hubs. When the inner and outer hubs are co-molded, on the other hand, the outer surface of the inner hub firmly adheres to the inner surface of the outer hub. However, in certain applications of the present invention, discontinuities can also be provided in order to enhance the degree of adherence between these meeting surfaces.

### BRIEF DESCRIPTION OF THE DRAWINGS

The present invention will be more fully and completely understood from a reading of the description of the preferred embodiment in conjunction with the drawings, in which:

FIG. 1 is a side section view of a propeller for a trolling motor made in accordance with a preferred embodiment of the present invention;

FIG. 2 shows an inner hub with a central opening formed therethrough;

FIG. 3 shows the inner hub of FIG. 2 with a propeller shaft extended through the central opening;

FIG. 4 is an end view of the inner hub with a plurality of discontinuities formed on an outer surface of the inner hub;

FIG. 5 is a side view of the inner hub shown in FIG. 4; and

FIGS. 6 and 7 illustrate an advantage of the present invention during an impact between propeller blades and a submerged object.

### DESCRIPTION OF THE PREFERRED EMBODIMENT

Throughout the description of the preferred embodiment of the present invention, like components will be identified by like reference numerals.

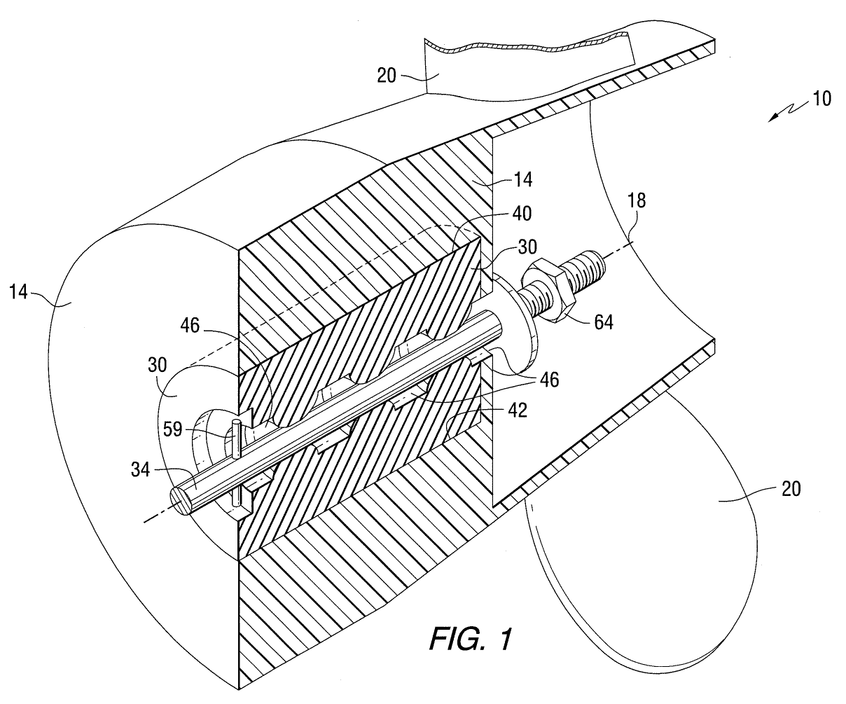

FIG. 1 illustrates a section view of a propeller made in accordance with a preferred embodiment of the present invention. The trolling motor propeller 10 comprises an outer hub 14 that is made of a first material and configured to be rotatable about a central axis 18. Blades 20 are attached to the outer hub 14. An inner hub 30, is made of a second material. The inner hub 30 is disposed radially inwardly of the outer hub 14, as shown in FIG. 1. The inner hub 30 is shaped to receive a propeller shaft 34 therethrough. The inner hub 30 is configured to be rotatable about the central axis 18.

The second material used to make the inner hub 30 is more elastically deformable than the first material used to make the outer hub 14. As an example, the inner hub 30 can be made of a synthetic elastomer, such as rubber. The outer hub 14 is typically made of a relatively hard plastic material or a metal, such as aluminum.

In certain embodiments of the present invention, the inner hub 30 is co-molded with the outer hub 14 to form an integral structure with the outer surface 40 of the inner hub 30 being permanently attached in adherence to the inner surface 42 of the outer hub 14. Alternatively, the inner hub 30 can be configured to be removably inserted into the outer hub 14.

FIG. 1 shows the propeller shaft 34 inserted through a central opening 46 of the inner hub 30. The propeller shaft 34 is maintained in a generally coaxial relationship with the central axis 18 by the shape and size of the central opening 46 as will be described in greater detail below.

The inner hub 30 can be provided with a plurality of discontinuities formed on its generally cylindrical outer surface 40. This will be described in greater detail below.

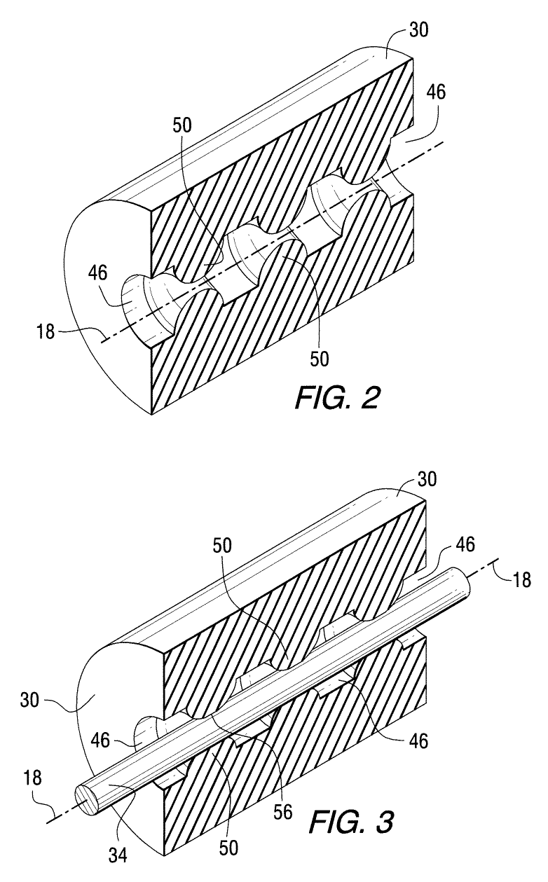

FIG. 2 is a cross-section view of the elastomeric inner hub 30. The central opening 46 is formed with a plurality of protrusions 50 that extend circumferentially around the internal surface of the central opening 46. These protrusions 50 define an elongate opening that is coaxial with the central axis 18 described above. The inwardly directed outer surfaces of the protrusions 50 are shaped and sized to receive the propeller shaft 34, which is described above in conjunction with FIG. 1, in a generally interference relationship. As the propeller shaft 34 is inserted into the opening 46, along the axis 18, the inwardly directed surfaces of the protrusions 50 cooperate with each other to maintain the propeller shaft 34 in coaxial relation with the central axis 18 and to maintain that relationship with regard to its position in the inner hub 30.

FIG. 3 shows the inner hub 30 with the propeller shaft 34 inserted into the opening along the central axis 18. As can be seen, the inwardly facing surfaces of the protrusions 50 are disposed in interfering relation with the propeller shaft 34 to hold it in place along the central axis. These surfaces 56 are slightly distorted and disposed in frictional contact with the outer surface of the propeller shaft 34 and, as a result of the elastic deformability of the second material, a radially inward force is provided by the surfaces 56 of the protrusions 50.

With reference to FIGS. 1 and 3, the propeller shaft 34 is also held in place relative to the inner hub 30 by a pin 60 and a nut 64. The attachment of a propeller shaft to a trolling motor propeller with a pin 60 and a nut 64 is generally known to those skilled in the art and will not be described in greater detail herein.

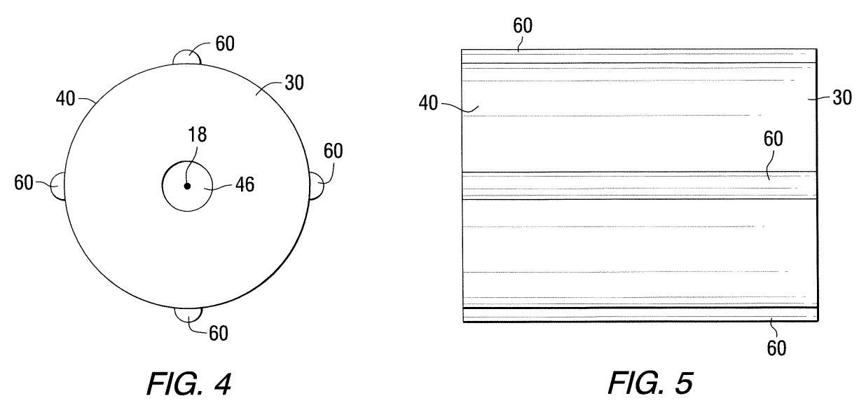

FIG. 4 is an end view of the inner hub 30, showing the central opening 46 and the central axis 18. In the embodiment shown in FIG. 4, the outer surface 40 of the inner hub 30 is provided with a plurality of exemplary discontinuities 60. In this example, the discontinuities 60 extend along the length of the inner hub 30 and are generally parallel with the central axis 18. However, it should be understood that alternative shapes and configurations of the discontinuities 60 can be implemented in alternative embodiments of the present invention.

FIG. 5 is a side view of the illustration shown in FIG. 4. It illustrates the positions of the discontinuities 60 on the outer surface 40 of the inner hub 30.

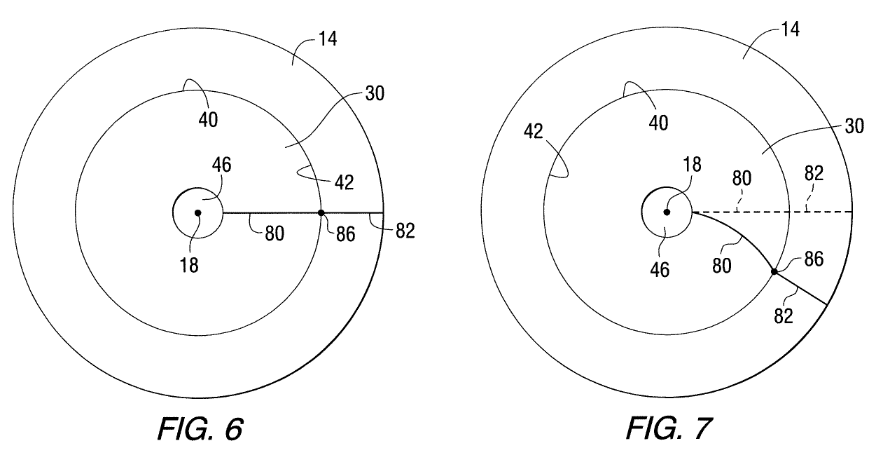

FIGS. 6 and 7 are intended to illustrate an advantage of the present invention. In FIG. 6, the inner hub 30 is shown within the outer hub 14. It should be understood that the outer surface 40 of the inner hub 30 and the inner surface 42 of the outer hub 14 are adhered to each other. If these two hubs are co-molded, these surfaces are permanently bonded to each other. If, alternatively, the inner hub 30 is disposed within the outer hub 14 in a removable manner, the shapes of the surfaces and the forces provided by the pin 60 and nut 64 maintain an intimate contact between the outer surface 40 and the inner surface 42. These surfaces, 40 and 42, are not intended to move relative to each other. To illustrate this beneficial effect of the present invention, two construction lines, 80 and 82, are shown in FIG. 6. With no torsional force exerted on the propeller or shaft, lines 80 and 82 are collinear as shown.

FIG. 7 shows the result of relative rotational movement between the outer hub 14 and inner hub 30. Dashed lines 80 and 82 in FIG. 7 show the original positions of these lines before relative rotational forces caused the outer hub 14 and inner hub 30 to rotate relative to each other. Solid lines 80 and 82 in FIG. 7 show the result of this relative movement. The outer hub 14 is rotated in a clockwise direction relative to the propeller shaft located in the central opening 46. This rotation is about the central axis 18. The inner hub 30 remains rigidly attached to the propeller shaft and its outer surface 40 remains rigidly attached to the inner surface 42 of the outer hub 14. This is illustrated by the point 86 which remains at its relative position with respect to the radially outer end of line 80 and radially inner end of line 82. This also illustrates no relative movement between surfaces 40 and 42. However, since the outer hub 14 rotated in a clockwise direction and the propeller shaft did not, elastic deformation occurs within the structure of the inner hub 30. This is represented by the non-linear shape of solid line 80 in FIG. 7 compared to its linear configuration in FIG. 6. This elastic deformation of the inner hub 30 absorbs the impact when a propeller blade 20 strikes an underwater object, such as a weed. Following that impact, the resiliency of the elastomeric material used to make the inner hub 30 elastically returns the outer hub 14 to its original position relative to the inner hub 30. In other words, solid lines 80 and 82 in FIG. 7 will return to the positions represented by dashed lines 80 and 82 as a function of the resilience of the elastically deformable material used to make the inner hub 30.

With reference to FIGS. 1-7, it can been seen that a propeller for a trolling motor made in accordance with a preferred embodiment of the present invention comprises an outer hub 14 of a first material, such as plastic or metal, and a plurality of blades 20 attached to the outer hub 14. The outer hub 14 is configured to be rotatable about a central axis 18. An inner hub 30 is made of a second material, such as a synthetic elastomer, and is disposed radially inwardly of the outer hub 14. The inner hub 30 is shaped to receive a propeller shaft 34 therethrough. The inner hub is configured to be rotatable about the central axis 18 with the outer hub 14. The second material, used to form the inner hub 30, is more elastically deformable than the first material used to form the outer hub 14.

In certain embodiments of the present invention, the inner hub 30 is configured to be removably inserted into the outer hub 14. However, in other embodiments of the present invention, the inner hub 30 is co-molded with the outer hub to provide a permanent adhesion between the outer surface 40 of the inner hub 30 and the inner surface 42 of the outer hub 14. The propeller 10 is attached to a trolling motor by inserting the propeller shaft 34 through a central opening 46 of the inner hub 30. The propeller shaft 34 is generally coaxial with the central axis 18. In certain embodiments of the present invention, particularly when the inner hub 30 is removably attached to the outer hub 14, a plurality of discontinuities can be formed on a generally cylindrical outer surface 40 of the inner hub 30. This enhances the attachment between the outer surface 40 of the inner hub 30 and the inner surface 42 of the outer hub 14.

Although the present invention has been described with particular specificity and illustrated to show a preferred embodiment, it should be understood that alternative embodiments are also within its scope.

1. A propeller for a trolling motor, comprising:
an outer hub made of a first material and configured to be rotatable about a central axis;
a plurality of blades attached to said outer hub; and
an inner hub made of a second material, said inner hub being disposed radially inwardly of said outer hub, said inner hub being shaped to receive a propeller shaft therethrough, said inner hub being configured to be rotatable about said central axis, wherein driving force from said propeller shaft is transferred through said inner hub to said outer hub along a radial direction by radial friction force and by torsional twisting of said inner hub.

2. The propeller of claim 1, wherein:
said second material is more elastically deformable than said first material.

3. The propeller of claim 1, wherein:
said inner hub is configured to be removably inserted into said outer hub.

4. The propeller of claim 1, wherein:
said inner hub is co-molded with said outer hub.

5. The propeller of claim 1, wherein:
said propeller shaft is inserted through a central opening of said inner hub, said propeller shaft being generally coaxial with said central axis.

6. The propeller of claim 1, wherein:
said first material is selected from the group consisting of a polycarbonate material and a metal.

7. The propeller of claim 1, wherein:
said second material is selected from the group consisting of natural and synthetic rubber.

8. The propeller of claim 1, wherein:
said first material is metal.

9. The propeller of claim 1, wherein:
said inner hub has a plurality of discontinuities formed on a generally cylindrical outer surface.

10. A propeller for a trolling motor, comprising:
an outer hub made of a first material and configured to be rotatable about a central axis;
a plurality of blades attached to said outer hub; and
an inner hub made of a second material, said second material being more elastically deformable than said first material, said inner hub being disposed radially inwardly of said outer hub, said inner hub being shaped to receive a propeller shaft therethrough, said inner hub being configured to be rotatable about said central axis, wherein driving force from said propeller shaft is transferred through said inner hub to said outer hub along a radial direction by radial friction force and by torsional twisting of said inner hub.

11. The propeller of claim 10, wherein:
said first material is selected from the group consisting of plastic and metal.

12. The propeller of claim 10, wherein:
said second material is a synthetic rubber compound.

13. The propeller of claim 11, wherein:
said inner hub is configured to be removably inserted into said outer hub.

14. The propeller of claim 11, wherein:
said inner hub is co-molded with said outer hub.

15. The propeller of claim 12, wherein:
said propeller shaft is inserted through a central opening of said inner hub, said propeller shaft being generally coaxial with said central axis.

16. The propeller of claim 11, wherein:
said inner hub has a plurality of discontinuities formed on a generally cylindrical outer surface.

17. A propeller for a trolling motor, comprising:
an outer hub made of a first material and configured to be rotatable about a central axis, said first material being selected from the group consisting of plastic and metal;
a plurality of blades attached to said outer hub; and
an inner hub made of a second material, said second material being more elastically deformable than said first material, said inner hub being disposed radially inwardly of said outer hub, said inner hub being shaped to receive a propeller shaft therethrough, said inner hub being configured to be rotatable about said central axis, said second material is a synthetic rubber compound, wherein driving force from said propeller shaft is transferred through said inner hub to said outer hub along a radial direction by radial friction force and by torsional twisting of said inner hub.

18. The propeller of claim 17, wherein:
said inner hub is configured to be removably inserted into said outer hub.

19. The propeller of claim 17, wherein:
said inner hub is co-molded with said outer hub.

20. The propeller of claim 17, wherein:
said inner hub has a plurality of discontinuities formed on a generally cylindrical outer surface.
